(19) United States
(12) Patent Application Publication
(10) Pub. No.: US 2003/0226418 A1
(43) Pub. Date: Dec. 11, 2003

(54) Secondary twist handle throttle control for A.T.V.

(76) Inventor: Arnold Howe, Las Vegas, NV (US)

Correspondence Address: Mark Campbell, 1170 East Parkstone Drive, Draper, UT, 84020, US

(21) Appl. No.: 10/166,939

(22) Filed: Jun. 11, 2002

(51) Int. Cl. F16C 1/10

(52) U.S. Cl. 74/502.2

(57) ABSTRACT

This invention is an additional throttle control which is easily installed on an All Terrain Vehicle. This additional throttle control is a twist handle throttle control which operates in addition to the original thumb throttle control used on all A.T.V.'s. This invention allows the operator a choice of two types of throttle control. The purpose of this invention is to give the operator an alternate throttle control when hand fatigue is caused by the original thumb throttle control during long distance travel. The new twist handle throttle control is much easier to use for long distance travel and does not cause hand fatigue. A locking device is provided for the new twist handle throttle control when safety concerns are required and the original thumb throttle control should be used solely.

### BACKGROUND OF THE INVENTION

1. Field of the Invention

This invention relates in general to throttle control devices and in particular to throttle control devices for All Terrain Vehicles wherein a twist handle throttle control is employed in addition to the original thumb throttle control.

2. Prior Art

I have not found any product on the market that provides a twist handle throttle control that allows the original thumb throttle control to remain in operation. The current after market twist throttle control devices require the removal of the original thumb throttle control. These after market devices utilize the cable used in the original thumb throttle control, thus making it necessary to remove the original thumb throttle control. This new invention allows a simple installation at a reduced cost with out disturbing the original thumb throttle control and allowing the A.T.V. operator a choice of either using the new twist handle throttle control or the original thumb throttle control. I have found nothing on the market that allows this dual mode of operation. This new invention also allows the operator a quick method for locking the new twist handle throttle control when safety concerns are required.

### SUMMARY OF THE INVENTION

In accordance with the present invention the Secondary Twist Handle Throttle Control comprises a metal tubing body with a lever connected to a wire rope which is connected to the original thumb throttle control. This new invention allows the operator to accelerate or decelerate with out interfering with the original thumb throttle control. A locking device can be employed when safety concerns are required.

### OBJECTS AND ADVANTAGES

The principal object and advantage of the present invention is to provide a secondary twist handle throttle control for A.T.V's. The standard thumb throttle control originally installed on A.T.V's. causes hand fatigue when used for an extended period of time. The solution to this problem is the Secondary Twist Handle Throttle Control. This new invention will allow you to travel for long distances without experiencing hand fatigue. The simple twist handle operation allows you to accelerate or decelerate with a twist motion found on most two wheeled motorized vehicles. It is important to note that the Secondary Twist Handle Throttle Control is installed in addition to the original thumb throttle control. This invention is simple to install and does not alter the original thumb throttle control operation.

The second principal object and advantage is to provide a quick method for locking the Secondary Twist Handle Throttle Control so that the original thumb throttle control may be used solely when a quick throttle release is needed. This quick throttle release may be needed when an operator is inexperienced or where the terrain may be extreme or steep grades exist.

The third principal object and advantage is to allow the operator a choice of either the Secondary Twist Handle Throttle Control or the original thumb throttle control when operating the A.T.V. on flatter grades or long distance travel. When this new invention, the Secondary Twist Handle Throttle Control, is installed both the new twist handle throttle and the original thumb throttle controls are fully operational.

### DRAWING FIGURES

FIG. 1 is a front perspective of the entire Secondary Twist Handle Throttle Control device installed next to the original thumb throttle control body and on the original handle bar of the A.T.V. The Secondary Twist Handle Throttle Control device has been shaded to highlight its position on the existing equipment.

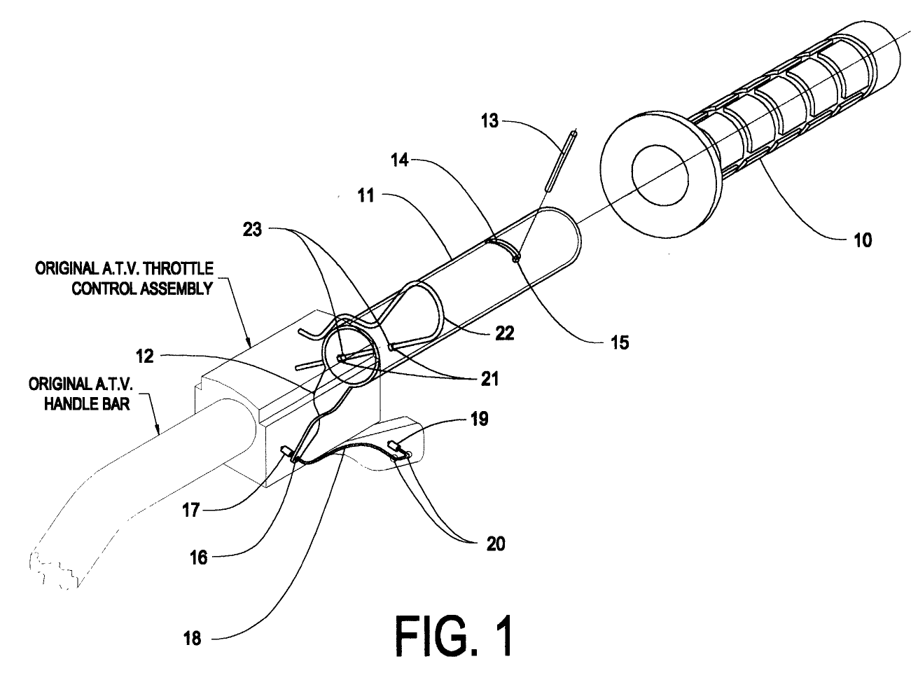

FIG. 2 is a front elevation of the entire Secondary Twist Handle Throttle Control device installed next to the original thumb throttle control body and on the original handle bar with the new handle bar grip in place shaded. A section through the device is represented in this view. The wire rope is not shown as a section in this view.

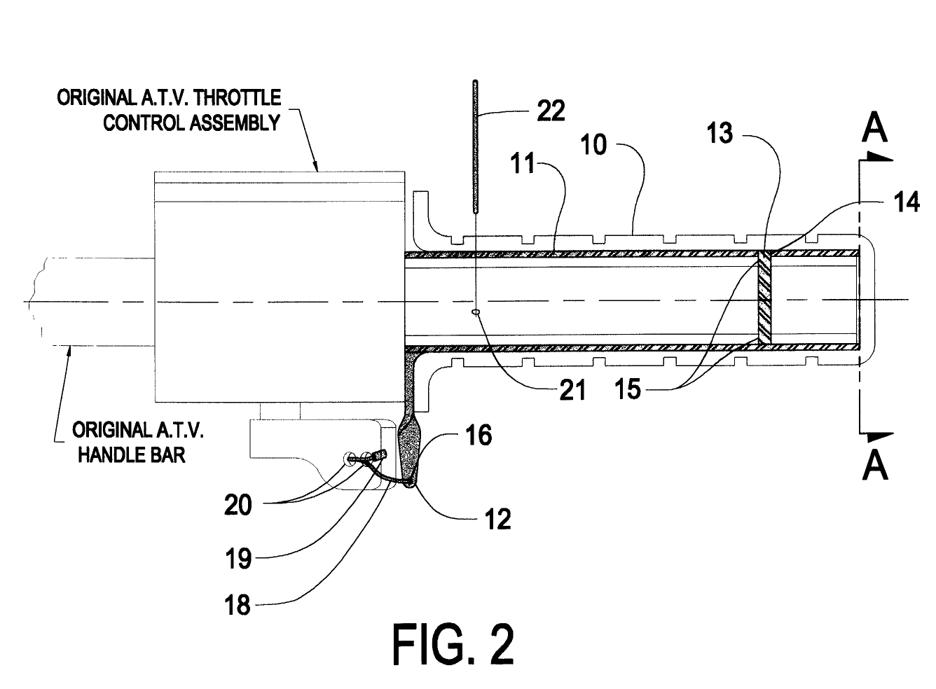

FIG. 3 is an end elevation of the entire Secondary Twist Handle Throttle Control device installed next to the original thumb throttle control body and on the original handle bar with the new handle bar grip in place. A section through the end of the new handle bar grip is shown.

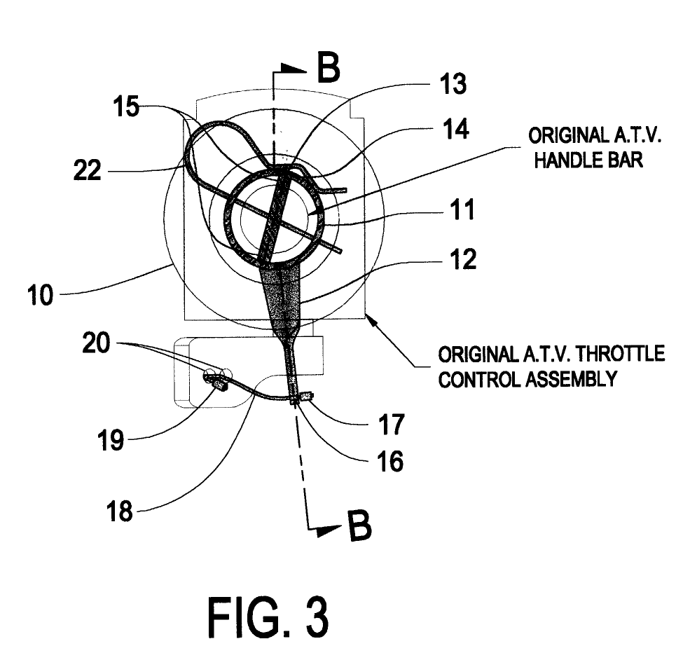

### REFERENCE NUMERALS IN DRAWINGS

10 new handle bar grip 11 metal tubing body

12 tapered lever 13 0.125″ pin

14 0.125″ wide slot 15 0.125″ hole in original handle bar

16 0.0625″ hole 17 swage for 0.0625″ wire rope

18 0.0625″ wire rope 19 swage for 0.0625″ wire rope

10 two 0.125″ holes 21 0.125″ hole in metal tubing body

22 hitch pin clip 23 0.125″ hole in original handle bar

### DETAILED DESCRIPTION

As shown in the drawings the preferred Secondary Twist Handle Throttle Control device in accordance with the present invention includes a metal tubing body 11 (hot rolled electric weld tubing 1″×4.50″×0.0625″) with a lever 12 that is fillet welded on one end. The lever 12 being 0.125″ steel, is twisted 90° at the midpoint of it's length, the width is tapered with the widest end attached to the metal tubing body 11 this end is 0.4375″ wide. The narrow end is 0.25″ wide. A 0.0625″ hole 16 is drilled at the narrow end to accommodate a 0.0625″ wire rope 18 with a 0.0625″ swage 17. The opposite end of the metal tubing body at 1.00″ from this end is a 0.125″ wide slot 14 at 0.625″ long being 135° referenced from the welded tapered lever 12. This slot 14 is to accommodate the 0.125″×0.935″ pin 13 that passes through a 0.125″ hole 15 drilled through the original handle bar of the A.T.V. This 0.125″ pin 13 holds the metal tubing body 11 in place on the original handle bar and allows a twist motion to take place. Two 0.125″ holes 20 are drilled in the original thumb throttle control to accommodate the 0.0625″ wire rope 18 with a 0.0625″ swage 19. For the Secondary Twist Handle Throttle Control to be operational the hitch pin clip 22 should be removed. This hitch pin clip 22 when in place provides a quick locking device for the Secondary Twist Handle Throttle Control when safety concerns are required. To install the new Secondary Twist Handle Throttle Control the original handle bar grip needs to be removed. Two 0.125″ holes 20 need to be drilled through the original thumb throttle control so the 0.0625″ wire rope 18 can be installed through the two 0.125″ holes 20 with the 0.0625″ swage 19. A simple hole drilling jig can be used to insure proper alignment when drilling the two 0.125″ holes 15 & 21 through the original handle bar. These two holes need to be drilled completely through the original handle bar. Install the metal tubing body 11 on to the original handle bar and place the 0.125″×0.935″ pin 13 in place. Place 0.0625″ wire rope 18 through the two 0.125″ holes 20 in the original thumb throttle control with the 0.0625″ swage 19. Then place the 0.0625″ wire rope 18 through the 0.0625″ hole 16 in the tapered lever 12 with the 0.0625″ swage 17. To finish this installation a rubber handle bar grip 10 is placed on to the metal tubing body 11.

I claim:

1. The Secondary Twist Handle Throttle Control device installed on the original handle bar of an All Terrain Vehicle will prevent hand fatigue experienced with the original A.T.V. thumb throttle control, this new device comprising a metal tubing body with a tapered lever which when twisted pulls an attached wire rope which said wire rope is attached to the original thumb throttle control and accelerates or decelerates the A.T.V.

2. The Secondary Twist Handle Throttle Control device installed on the original handle bar of an All Terrain Vehicle allows a locking device to be employed when safety concerns are required comprising a metal tubing body with a tapered lever which when twisted pulls an attached wire rope which said wire rope is attached to the original thumb throttle control and accelerates or decelerates the A.T.V. said locking device (the hitch pin clip) when employed will make the new Secondary Twist Handle Throttle Control device inoperable.

3. The Secondary Twist Handle Throttle Control device installed on the original handle bar of an All Terrain Vehicle allows a dual mode of operation, both the original thumb throttle control or the Secondary Twist Handle Throttle Controls are fully operational comprising a metal tubing body with a tapered lever which when twisted pulls an attached wire rope which said wire rope is attached to the original thumb throttle control and accelerates or decelerates the A.T.V.
